(19) United States
(12) Patent Application Publication
(10) Pub. No.: US 2006/0073427 A1
(43) Pub. Date: Apr. 6, 2006

(54) Silver halide photographic sensitive material

(75) Inventor: Motoi Nishimura, Hinoshi (JP)

Correspondence Address: FRISHAUF, HOLTZ, GOODMAN & CHICK, PC, 220 Fifth Avenue, 16TH Floor, NEW YORK, NY, 10001-7708, US

(73) Assignee: KONICA MINOLTA PHOTO IMAGING, INC., Tokyo (JP)

(21) Appl. No.: 10/543,618

(22) PCT Filed: Feb. 14, 2003
(86) PCT No.: PCT/JP03/01533

§ 371 Date: Jul. 28, 2005

(51) Int. Cl. G03C 7/00

(52) U.S. Cl. 430/365

(57) ABSTRACT

The present invention relates to a silver halide photographic material exhibiting superior process stability even when processed at a relatively low replenishing rate. The silver halide photographic material comprising on a support at least one silver halide emulsion layer is characterized in that the silver halide emulsion layer contains at least two image-forming couplers represented by the following formula (M-1) or (M-2), in which the difference in number of carbon atoms of the alkyl group contained in the substituent represented by R₂ or R₃ is at least 2 between the two couplers; and the photographic material is developed with a color developer solution at a replenishing rate of a color developer replenishing solution of 30 to 100 ml per 1 m², and the color developer replenishing solution containing a color developing agent in an amount of 5.0 to 20 g/L.

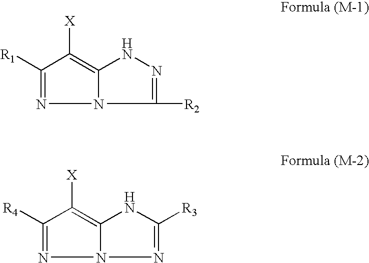

### FIELD OF THE INVENTION

The present invention relates to a silver halide photographic light-sensitive material which is exposed and processed to prepare a color print, and in particular to a silver halide photographic material exhibiting superior process stability even when processed at a relatively low replenishing rate.

### BACKGROUND OF THE INVENTION

In general, color developer solutions and color developer replenishing solutions which contain an aromatic primary amine developing agent are known to be auto-oxidized to cause change in composition of the solution when allowed to stand in contact with air.

Specifically, recent popularization of minilabs has resulted in an increase of on-site processing of camera shops and DP-service shops. On the other hand, reduction of processing effluent has been desired from the point of view of environmental preservation.

In response thereto, stabilization of processing solutions and reduced replenishment-rate of processing solutions have been promoted for photographic processing of silver halide photographic material (hereinafter, also denoted simply as photographic material). As an approach to a low replenishment-rate of processing solution, for example, with respect to color developer solution, a developer rejuvenation method in which overflowed solution is subjected to an ion-exchange treatment or electrodialysis and a method in which overflowed solution is supplemented with regenerating agents and used as a replenisher solution, were proposed and put into practical use.

In reduction of the replenishment-rate, stabilization of replenisher solution and quality stabilization of photographic materials to be processed are of most importance. A low replenishment-rate results in a prolonged retention time in a replenisher tank of a prescribed volume. Accordingly, there is prolonged the duration of the open area of a color developer replenishing solution being in contact with air. A replenisher tank is often built-in on the side of a processing tank from the design point of view of an automatic processor, forming a longitudinally long rectangular tank. When a color developer replenishing solution fills such a replenisher tank, the air contact area is relatively small but the liquid amount lessens with replenishment. When the liquid amount becomes half or less of the replenisher tank volume, the relative air contact area per unit volume of the replenisher solution gradually increases. Reduction of the replenishment rate prolongs the air-contact, thereby promoting oxidation of the color developer replenishing solution. Aromatic primary amine color-developing agents used in color developer solution and their replenisher solutions are readily oxidized with ambient air so that antioxidants or preservatives are usually used concurrently.

Recently, there has been an increase in the number of minilab shops, called 1 Hour Photo, which trade on short time processing (at 45 min. to 1 hr.), so-called rapid access. In response to such rapid access, color paper of a high chloride content exhibiting superior processability has become popular. Adding a large amount of a preservative to prevent aerial oxidation, e.g., a sulfite or a hydroxylamine to a color developer solution promotes the solution physical development and dissolves silver halide nuclei having a latent image nucleus, preventing reaction with a color developing agent, resulting in reduction in sensitivity or color density.

As antioxidant for color developer solution which exhibit no adverse effect on developability of a photographic material using a high chloride silver halide emulsion, is known the use of alkanol amines described in JP-A No. 62-250444 (hereinafter, the term, JP-A refers to Japanese Patent Application Publication), the use of dialkylhydroxylamines described in JP-A No. 63-32547, and the use of hydrazine derivatives described in JP-A No. 63-48548.

When color processing is performed at a low replenishing rate, it needs to maintain a color developing agent in a color developer replenishing solution at a relatively high concentration of at least 9 g/L or sometimes, at least 11 g/L. Almost all ordinarily used color-developing agents are p-phenylenediamine type compounds. These p-phenylenediamine compounds exhibit the defect of being readily deposited as crystals in an extremely high alkaline solution such as a developer solution having a pH of 10 to 12. To compensate for such a defect, JP-A No. 3-59654 discloses a technique of using naphthalenesulfonic acid derivatives.

In general, a replenisher solution is composed of an accumulation of compounds which were leached out of the processed photographic material and replenishment of consumed compounds. For example, a color developer replenishing solution performs replenishment of development-active material consumed during processing, such as a color developing agent, correction for the quantity of inhibiting material such as halide ions or inhibitors which are leached out of the processed photographic material and accumulated therein, or pH correction. Thus, there is usually used a replenishing solution having a higher concentration of a color-developing agent, a lower inhibitor concentration and a higher pH than a conventional color developer solution.

Performing replenishment at a low replenishing rate using a high concentrate replenishing solution having the foregoing characteristics temporarily causes variation in pH in the region where the replenishing solution has been replenished. Specifically, when pyrazolotriazole type magenta couplers exhibiting superior color reproduction and dye forming capability, as described in U.S. Pat. Nos. 3,725,065, 3,810,761, 3,758,309 and 3,725,067 are employed, their dye forming capabilities (such as sensitivity, contrast and maximum density) are easily influenced by localized pH variation in the color developer solution under low replenishment conditions.

Magenta dyes obtained from pyrazoloazole type magenta couplers as described above are known to be inferior in light fastness, compared to those obtained from 5-pyrazolone type magenta couplers, and many techniques for improvement were proposed. There are known techniques of employing phenol or phenyl ether compounds described in JP-A Nos. 56-159644, 59-125732, 61-145552, 60-262159, 61-90155 and 3-39956; amine compounds described in JP-A Nos. 61-73152, 61-72246, 61-18953961-189540 and 63-95439; metal complex compounds described in JP-A Nos. 61-140941, 61-145554, 61-158329 and 62-183459; inclusion compounds described in JP-A No. 2-100048 and heterocyclic compounds.

However, as a result of the inventor's study, it was proved that the use of pyrazoloazole type magenta couplers in combination with phenol type compounds or amine type compounds as an enhancing agent for light fastness (or dye image stabilizer) resulted in further increased variation in performance, caused by local pH variation of the color developer solution under low replenishment conditions, as described above.

Methods for improving such pH variability of a color developer solution of pyrazoloazole type magenta couplers were proposed (as described, for example, in patent documents 1 and 2). There was also disclosed a method of improving the foregoing pH variability by improving the structure of silver halide grains, included a silver halide photographic material containing pyrazoloazole type magenta couplers (as described, for example, in patent document 3). However, neither of the foregoing proposals has reached a satisfactory level in recent processing at a low replenishment rate and still further improvement is desired.

Accordingly, it is an object of the invention to provide a silver halide photographic material exhibiting superior process stability, specifically, stability for pH variation, even when processed at a low replenishment rate.

Patent Document 1:
JP-A No. 4-269743 (scope of patent claims) Patent document 2:
JP-A No. 6-214360 (scope of patent claims) Patent document 3:
JP-A No. 6-250316 (scope of patent claims)

### DISCLOSURE OF THE INVENTION

The foregoing object of the invention can be accomplished by the following constitution:

(1) A silver halide photographic material comprising on a support at least one silver halide emulsion layer, wherein the silver halide emulsion layer contains at least two image-forming couplers represented by the following formula (M-1) or (M-2); the photographic material is developed with a color developer solution while replenishing a color developer replenishing solution at a replenishing rate of 30 to 100 ml per 1 m², and the color developer replenishing solution containing a color developing agent in an amount of 5.0 to 20 g/L: 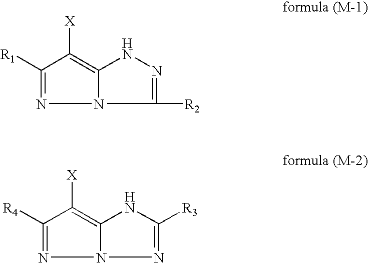
wherein R₁ and R₄ are each a hydrogen atom or a substituent;
R₂ and R₃ are each a substituent, provided that the substituent represented by R₂ or R₃ contains an alkyl group having at least 6 carbon atoms and a difference in number of carbon atoms of the alkyl group contained in the substituent represented by R₂ or R₃ between the two couplers is at least 2; X is a group capable of being released upon reaction with an oxidation product of a color developing agent;

(2) The silver halide photographic material as described in (1), wherein the silver halide emulsion layer containing the couplers represented by formula (M-1) or (M-2) further contains a compound represented by the following formula (I) or (II): 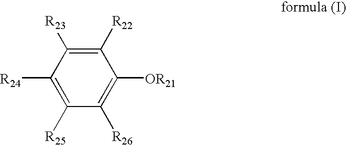
wherein R₂₁ is a hydrogen atom, an alkyl group, an aryl group, a heterocyclic group or a group represented by the following formula: 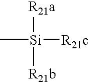
in which R₂₁a, R₂₁b and R₂₁c are each a univalent organic group; R₂₂, R₂₃, R₂₄, R₂₅ and R₂₆ are each a hydrogen atom, a halogen atom or a group capable of being substituted on a benzene ring, provided that R₂₁ to R₂₆ may combined with each other to form a ring; 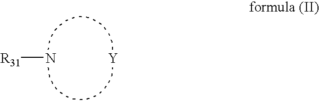
wherein R₃₁ is an aliphatic group or an aromatic group; Y is a non-metallic atom group necessary to form a 5- to 7-membered ring together with a nitrogen atom;

(3) The silver halide photographic material as described in (1) or (2), wherein the couplers represented by formula (M-1) or (M-2) exhibit a pKa of not less than 9.5.

### PREFERRED EMBODIMENT OF THE INVENTION

The silver halide photographic material comprising on a support at least one silver halide emulsion layer is characterized in that the silver halide emulsion layer contains at least two image-forming couplers represented by the formula (M-1) or (M-2), in which the difference of the number of carbon atoms between alkyl groups represented by R₂ or R₃ is not less than 2, and the photographic material is developed with a color developer solution at a replenishing rate of a color developer replenishing solution of 30 to 100 ml per m², and the color developer replenishing solution contains a color developing agent at 5.0 to 20 g/L. The constitution, as defined in the invention can achieve a silver halide photographic material exhibiting superior process stability, specifically, stability for pH variation, even when processed at a relatively low replenishing rate.

One feature of the invention is that the silver halide photographic material contains at least two image forming magenta couplers.

There will be described an image forming coupler represented by formula (M-1) or (M-2).

In the formula (M-1) or (M-2), R₁ and R₄, each represents a hydrogen atom or a substituent. The substituent of R₁ or R₄ is not specifically limited and representative examples thereof include alkyl, aryl, anilino, acylamino, sulfonamido, alkylthio, arylthio, alkenyl and cycloalkyl groups, and further include a halogen atom, and cycloalkenyl, alkynyl, heterocycle, sulfonyl, sulfinyl, phosphonyl, acyl, carbamoyl, sulfamoyl, cyano, alkoxy, aryloxy, heterocycleoxy, siloxy, acyloxy, carbamoyloxy, amino, alkylamino, imido, ureido, sulfamoylamino, alkoxycarbonylamino, aryloxycarbonylamino, alkoxycarbonyl, aryloxycarbonyl and heterocycle-thio groups, spiro compound moiety and bridged hydrocarbon moiety.

The alkyl group of R₁ or R₄ is preferably one having 1 to 32 carbon atoms, which may be a straight chain or branched.

The aryl group of R₁ or R₄ is preferably a phenyl group.

Examples of the acylamino group of R₁ or R₄ include an alkylcarbonylamino group and arylcarbonylamino group.

Examples of the sulfonamido group of R₁ or R₄ include an alkylsulfonylamino group and arylsulfonylamino group.

Alkyl and aryl components of the alkylthio and arylthio groups of R₁ or R₄ include an alkyl and aryl groups of the foregoing R₁ and R₄.

The alkenyl group of R₁ or R₄ is preferably one having 2 to 32 carbon atoms, and the cycloalkyl group is preferably one having 3 to 12 carbon atoms and more preferably one having 5 to 7 carbon atoms, which may be a straight chain or branched.

The cycloalkenyl group of R₁ and R₂ is preferably one having 3 to 12 carbon atoms and more preferably 5 to 7 carbon atoms.

Of the substituents represented by R₁ and R₂, the sulfonyl group includes an alkylsulfonyl and an arylsulfonyl; the sulfonyl group includes an alkylsulfonyl group and an arylsulfonyl group; the phosphonyl group includes an alkylphosphonyl group, an alkoxyphosphonyl group and an arylphosphonyl group; the acyl group includes an alkylcarbonyl group and an arylcarbonyl group; the carbamoyl group includes an alkylcarbamoyl group and an arylcarbamoyl group; the sulfamoyl group includes an alkylsulfamoyl group and an arylsulfamoyl group; the acyloxy group includes an alkylcarbonyloxy group and an arylcarbonyloxy group; the carbamoyloxy group includes an alkylcarbamoyloxy group and an arylcarbamoyloxy group; the ureidb group includes an alkylureido group and an arylureido group; a sulfamoylamino group includes an alkylsulfamoylamino group and an arylsulfamoylamino group; the heterocyclic group is preferably a 5- to 7-membered ring one, such as 2-fury; group, 2-thienyl group, 2-pyrimidinyl group, and 2-benzothiazolyl group; the heterocycle-oxy group is preferably one having a 5- to 7-membered heterocycle, such as 3,4,5,6-tetrahydropyranyl-2-oxy and 1-phenyltetrazole-5-oxy; the heterocycle-thio group is preferably one having a 5- to 7-membered heterocycle, such as 2-pyridylthio, 2-benzothiazolylthio and 2,4-diphenoxy-1,3,5-triazole-6-thio; the siloxy group includes a trimethylsiloxy group, triethylsiloxy group and dimethylbutylsiloxy group; the imido group includes a succinic acid imido group, 3-heptadecylsuccinic acid imido group, a phthalic acid imido and a glutaric acid imido; the spiro compound moiety includes spiro[3.3]heptane-1-yl; the and bridged hydrocarbon moiety includes bicyclo[2.2.1]heptane-1-yl, tricyclo[3.3.1.13.7]decane-yl and 7,7-dimethyl-bicyclo[2.2.1]heptane-1-yl.

Examples of a group capable of being released upon reaction with an oxidation product of a color developing agent, represented by X include a halogen atom (e.g., chlorine atom, bromine atom, fluorine atom, etc.), alkoxy, aryloxy, heterocycle-oxy, acyloxy, sulfonyloxy, alkoxycarbonyloxy, aryloxycarbonyl, alkyloxalyloxy, alkoxyoxalyloxy, alkylthio, arylthio, heterocycle-thio, alkyloxythiocarbonylthio, acylamino, sulfonamido, N-attached nitrogen-containing heterocyle, alkyloxycarbonylamino, aryloxycarbonylamino, carboxyl, and 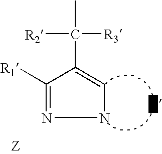
where R₁′ is the same as defined in R₁ and R₄; Z′ is a non-metallic atom group necessary to form a nitrogen-containing heterocyclic ring, the ring formed by Z′ may be substituted and examples thereof include a pyrazole ring, an imidazole ring, a triazole ring and a tetrazole ring; R₂′ and R₃′ are each a hydrogen atom, an aryl group, an alkyl group or a heterocyclic group.

The substituent of R₂ and R₃ is the same as defined in R₁ and R₄, provided that the substituent of R₂ or R₃ contains an alkyl group having at least 6 carbon atoms. The substituent of R₂ or R₃ preferably contains a straight-chained alkyl group, and the straight-chain alkyl group preferably has at least 6 carbon atoms and more preferably at least 10 carbon atoms.

The image forming coupler, represented by formula (M-1) or (M-2) preferably exhibits a pKa of not less than 9.5, more preferably from 9.5 to 11.5, and still more preferably from 10.0 to 11.0. The use of an image forming coupler exhibiting a pKa, as defined above can fully display the object and effect of the invention.

Specific examples of a magenta coupler represented by the foregoing formula (M-1) are shown below but the invention is not limited to these.

| | R₁ | R₂ | X |
|---|---|---|---|
| 1 | —CH₃ | (CH₂)₃SO₂C₁₄H₂₉ | Cl |
| 2 | —CH₃ | (CH₂)₃SO₂C₁₆H₃₃ | Cl |
| 3 | —CH₃ | —C₁₃H₂₇ | Cl |
| 4 | —CH₃ | —C₁₅H₃₁ | Cl |
| 5 | —C₃H₇(i) | —(CH₂)₃SO₂C₁₂H₂₅ | Cl |
| 6 | —C₃H₇(i) | —(CH₂)₃SO₂C₁₄H₂₉ | Cl |
| 7 | —C₄H₉(t) | —(CH₂)₃SO₂C₁₂H₂₅ | Cl |
| 8 | —C₄H₉(t) | —(CH₂)₃SO₃C₁₄H₂₉ | Cl |
| 9 | —C₄H₉(t) | —C₁₃H₂₇ | Cl |
| 10 | —C₄H₉(t) | —C₁₅H₃₁ | Cl |
| 11 | —C₄H₉(t) | 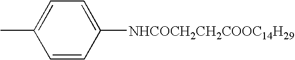 | Cl |
| 12 | —C₄H₉(t) | 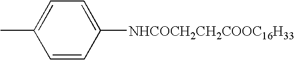 | Cl |
| 13 | —C₄H₉(t) | 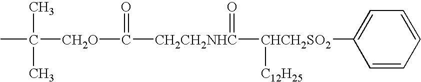 | Cl |
| 14 | —C₄H₉(t) | 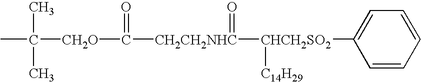 | Cl |
| 15 | —C₄H₉(t) | 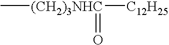 | Cl |
| 16 | —C₄H₉(t) | 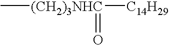 | Cl |

Specific examples of a magenta coupler represented by the foregoing formula (M-2) are also shown below but the invention is not limited to these.

| | R₄ | R₃ | X |
|---|---|---|---|
| 17 | —CH₃ | 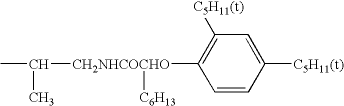 | Cl |
| 18 | —CH₃ | 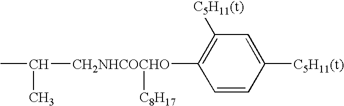 | Cl |
| 19 | —C₃H₇(i) | 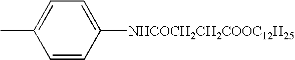 | Cl |
| 20 | —C₃H₇(i) | 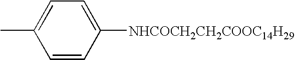 | Cl |
| 21 | —C₄H₉(t) | 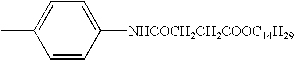 | Cl |
| 22 | —C₄H₉(t) | 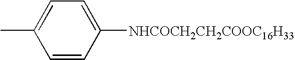 | Cl |
| 23 | —C₄H₉(t) | —(CH₂)₃SO₂C₁₂H₂₅ | Cl |
| 24 | —C₄H₉(t) | —(CH₂)₃SO₂C₁₄H₂₉ | Cl |
| 25 | —C₄H₉(t) | —C₁₃H₂₇ | Cl |
| 26 | —C₄H₉(t) | —C₁₅H₃₁ | Cl |

In addition to specific examples of the formulas (M-1) and (M-2), as describe above, specific examples of magenta couplers (M-1) and (M-2) include compounds described in JP-A No. 62-166339, pages 18-32. The magenta couplers represented by formula (M-1) or (M-2) can be readily synthesized by a person skilled in the art, with reference to, for example, Journal of the Chemical Society, Perkin I (1977), 2047-2052; U.S. Pat. No. 3,725,067; JP-A Nos. 59-99437, 58-42045, 59-162548, 59-171956, 60-33552, 60-43659, 60-172982, 60-190779, 61-189539, 61-241754, 63-163351, and 62-157031; Syntheses, 1981, page 40, ibid 1984, page 122, ibid 1984, page 894; JP-A No. 49-53574; British Patent No. 1,410, 846; “Shin-Jikken Kagaku Koza” vol. 14-III, page 1585-1594 (1977), Maruzen; Helv. Chem. Acta., vol. 36, page 75 (1953); J. Am. Chem. Soc., 72, 2762 (1950); Org. Synth. vol. II, 395 (1943).

In the silver halide photographic material of the invention, the magenta couplers of formula (M-1) or (M-2) can be used in a total amount of 1×10⁻³ to 1 mol per mol of silver halide, and preferably 1×10⁻² to 8×10⁻¹ mol.

The magenta couplers of formula (M-1) or (M-2) can be used in combination with other magenta couplers.

The magenta couplers of formula (M-1) or (M-2) can be incorporated into the silver halide emulsion layer according to the conventional method. For example, magenta couplers of formula (M-1) or (M-2) are dissolved in a mixture of a commonly known high boiling solvent such as dibutyl phthalate or tricresyl phthalate and a low boiling solvent such as butyl acetate or ethyl acetate, or in a low boiling solvent alone, mixed with an aqueous gelatin solution containing a surfactant, and emulsified using a high-speed rotary mixer, a colloid mill or a ultrasonic dispersing machine. The emulsified dispersion is directly added to the silver halide emulsion. Alternatively, after the emulsified dispersion is set, cut finely and washed, the dispersion may be added to the emulsion.

Magenta couplers of formula (M-1) and (M-2) each may be dispersed separately according to the foregoing dispersion method using a high boiling solvent and added to the emulsion. However, it is preferred that both compounds are simultaneously dissolved, dispersed and added to the emulsion.

The amount of the high boiling solvent to be added is preferably from 0.01 to 10 g per 1 g of the total amount of magenta couplers of formula (M-1) or (M-2), and more preferably from 0.1 to 3.0 g.

In the silver halide photographic material of the invention, the silver halide emulsion layer containing at least two magenta couplers of formula (M-1) or (M-2) preferably contains the compound represented by formula (I) or (II).

Hereinafter, dye image stabilizers represented by the foregoing formula (I) or (II) will be described in detail.

I the formula (I), an alkyl group represented by R₂₁ preferably has 1 to 32 carbon atoms, which may be straight chain or branched. An aryl group represented by R₂₁ preferably is a phenyl group. A heterocyclic group represented by R₂₁ preferably is a 5- to 7-membered ring and specific examples thereof include 2-furyl, 2-thienyl, 2-pyridyl and 2-benzothiazolyl.

Examples of a monovalent organic group, represented by R₂₁ₐ, R_{21b} and R_{21c} include an alkyl group, an aryl group, an alkoxy group, an aryloxy group, and a halogen atom. R₂₁ is preferably a hydrogen atom or an alkyl group.

The group capable of being substituted on a benzene ring of R₂₂ to R₂₆ is not specifically limited but examples thereof include alkyl, aryl, anilino, acylamino, sulfonamido, alkylthio, arylthio, alkenyl, and cycloalkyl groups, and further include a halogen atom, and cycloalkenyl, alkynyl, heterocycle, sulfonyl, sulfinyl, phosphonyl, acyl, carbamoyl, sulfamoyl, cyano, alkoxy, aryloxy, heterocycle-oxy, siloxy, acyloxy, carbamoyloxy, amino, alkylamino, imido, ureido, sulfamoylamino, alkoxycarbonylamino, aryloxycarbonylamino, alkoxycarbonyl, aryloxycarbonyl and heterocycle-thio groups, spiro compound moiety and bridged hydrocarbon moiety.

R₂₂, R₂₃, R₂₅ and R₂₆ are each preferably a hydrogen atom, hydroxy group, alkyl group, aryl group, alkoxy group, aryloxy or acylamino group; R₂₄ is preferably an alkyl group, hydroxy, aryl group, alkoxy group, or aryloxy group. R₂₁ and R₂₂ may combine with each other to form a 5- or 6-membered ring, in which R₂₄ is preferably hydroxy group, an alkoxy group or an aryloxy group. R₂₁ and R₂₂ may combine with each other to form a methylenedioxy ring. R₂₃ and R₂₄ may combine with each other to a 5-membered hydrocarbon ring, in which R₂₁ is preferably an alkyl, aryl or heterocyclic group.

Specific examples of the compound of formula (I) are shown below.

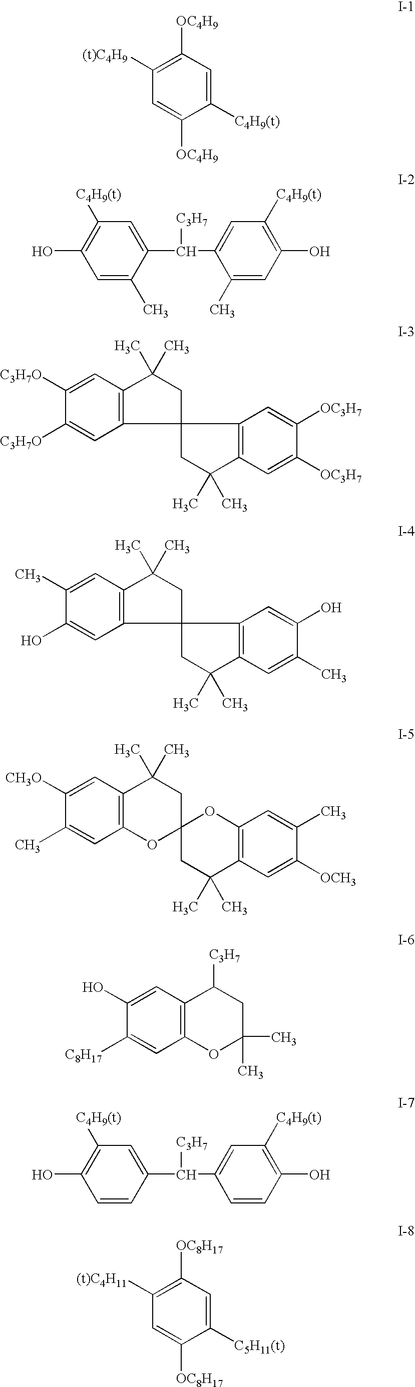

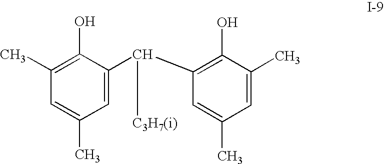

In addition to the foregoing examples, specific examples of the compound of formula (I) include exemplified compounds A-1 to A-28 described in JP-A No. 60-262159, page 11-13; exemplified compounds PH-1 to PH-29 described in JP-A No. 61-145552; exemplified compounds B-1 to B-21 described in JP-A No. 1-306846; exemplified compounds I-1 to I-13, I′-1 to I′-8, II-1 to II-12, II′-1 to II′-21, III-1 to III-14, IV-1 to IV-24, and V-13 to V-17 described in JP-A No. 2-958; exemplified compounds II-1 to II-33 described in JP-A No. 3-39956, page 10-11.

In the formula (II), R₃₁ is an aliphatic group or an aromatic group, preferably an alkyl group, aryl group or a heterocyclic group, and more preferably an aryl group. Examples of a heterocyclic ring formed by Y with a nitrogen atom, include a piperidine ring, piperazine ring, morpholine ring, thiomorpholine ring, thiomorpholine-1,1-dione ring, and pyrrolidine ring.

Specific examples of the compound represented by formula (II) are shown below.

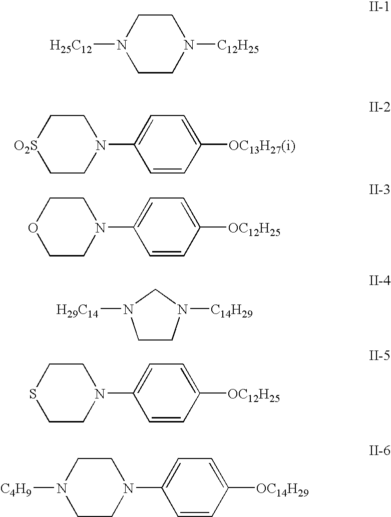

In addition to the foregoing examples, specific examples of the compound of formula (II) include exemplified compounds B-1 to B-65 described in JP-A No. 2-167543, page 8-11; exemplified compounds (19 to (120) described in JP-A No. 63-95439, page 4-7.

The amount of a compound of formula (I) or (II) to be added, is preferably 5 to 500 mol % of the magenta coupler of the invention, and more preferably 20 to 200 mol %. Two or more of the foregoing compounds may be used in combination.

The magenta couplers of formula (M-1) or (M-2), and the compound (dye image stabilizer) of formula (I) or (II) are incorporated preferably in the same layer, but the dye image stabilizer is optionally incorporated into the layer adjacent to the layer containing the couplers.

The composition of a silver halide emulsion used in the invention may contain any halide composition, silver chloride, silver bromide, silver chlorobromide, silver iodobromide, silver iodochlorobromide, and silver iodochloride. Silver bromochloride having a chloride content of not less than 95 mol % and substantially having no iodide is preferred in terms of rapid-processability and process stability, and a silver halide emulsion having a chloride content of not less than 97 mol % (still more preferably 98 to 99.9 mol %) is more preferred.

To reduce a decrease in contrast in the high density region of a characteristic curve obtained when the photographic material of the invention is exposed at a high intensity for a short period of time, a silver halide grain emulsion having a high bromide portion. The high bromide portion may be attached to silver halide grains through epitaxial junction or may be a so-called core/shell emulsion. There may exist regions which partially differ in composition, without forming a complete layer. The composition may vary continuously or may vary non-continuously. The high bromide portion locates preferably on the surface of the silver halide grain or in the corner of the grain.

To reduce a decrease in contrast when the photographic material of the invention is subjected to scanning exposure at a high intensity for a short period of time, the use of silver halide grains including heavy metal ions is preferred. Heavy metal ions usable for such purposes include group 8 to 10 metals such as iron, iridium, platinum, palladium, nickel, rhodium, osmium, ruthenium, and cobalt, group 12 transition metals such as cadmium zinc and mercury, and ions of rhenium, molybdenum, tungsten, gallium, and chromium. Of these, metal ions of iron, iridium, platinum, ruthenium, gallium and osmium are preferred. These metal ions can be added to the silver halide emulsion in the form of a salt or complex salt.

When the foregoing heavy metal ions form complexes, ligands or their ions include a cyanide ion, a thiocyanate ion, a cyanate ion, an isothiocyanate ion, a chloride ion, a bromide ion, an iodide ion, a nitrate ion, carbonyl, and ammonia. Of these, a cyanide ion, a thiocyanate ion, an isocyanate ion, a chloride ion and a bromide ion are preferred.

To the heavy metal ions to be included in silver halide grains, the heavy metal compound is added at any stage before forming silver halide grains, during formation of silver halide grains, after formation of silver halide grains or during physical ripening. Addition of an aqueous solution of a heavy metal compound can be conducted over the whole of the grain formation stage or a part thereof.

The heavy metal ions are added to a silver halide emulsion, preferably in an amount of not less than 1×10⁻⁹ mol and not more than 1×10⁻² mol per mol of silver halide, and more preferably not less than 1×10⁻⁸ mol and not more than 5×10⁻⁵ mol.

Silver halide grains of any form can be used in the photographic material of the invention. Preferred embodiments include cubic grains having a (100) face as the crystal surface. Octahedral, tetradecahedral or dodecahedral grains can also be prepared according to methods described in U.S. Pat. Nos. 4,183,756 and 4,225,666, JP-A No. 55-26589, JP-B No. 55-42737 (hereinafter, the term, JP-B refers to Japanese Patent Publication), and J. Photogr. Sci., 21, 39 (1973). Further, grains having twinned plane(s) are also usable.

In the photographic material of the invention, silver halide grains is comprised of grains having a single form, and it is specifically preferred that at least two kinds of monodisperse silver halide emulsions be incorporated into the same layer.

The grain size of silver halide grains relating to the invention is not specifically limited but is preferably in the range of 0.1 to 1.2 μm in terms of rapid-processability and sensitivity, and more preferably 0.2 to 1.0 μm.

The grain size can be determined using the grain projected area or diameter-approximate value. When the grains have a substantially uniform shape, the grain size distribution of the grains can be precisely represented by a diameter or projected area.

With respect to the grain size distribution of silver halide grains used in the photographic material of the invention, monodisperse silver halide grains having a coefficient of variation of nor more than 0.22, and preferably not more than 0.15 is preferred. It is specifically preferred to add at least two monodisperse emulsions having a coefficient of variation of not more than 0.15 to the same layer. The coefficient of variation, which is a coefficient representing the width of grain size distribution, is defined by the following equation:
Coefficient of variation=S/R
wherein S is a standard deviation of grain size distribution, and R is an average grain size. In the case of spherical silver halide grains, the grain size is a diameter, and in the case of grains of a form other than a cube or sphere, the grain size is represented by a diameter of a circle having the same area as the projected area.

Silver halide emulsions can be prepared by various methods and manufacturing apparatuses known in the art.

The silver halide emulsion used in the photographic material of the invention may be any one which is obtainable in the acid process, neutral process or ammonia process. The grains may be those which are grown at one time or grown after forming seed grains. The method of preparing seed grains and that of growing the seed grains may be the same or different.

The reaction mode of a water-soluble silver salt with water-soluble halide salts may be any one of a normal precipitation method, a reverse precipitation method and a double-jet precipitation method, and the double-jet precipitation method is preferred. A pAg-controlled double-jet precipitation method described in JP-A No. 54-48521 is preferably employed as one mode of the double-jet precipitation.

There may be used an apparatus in which an aqueous solution of a water-soluble silver salt and an aqueous solution of a water-soluble halide salt are supplied from an addition apparatus arranged in the reaction mother liquor, as described in JP-A Nos. 57-92523 and 57-92524; an apparatus in which an aqueous solution of a water-soluble silver salt and an aqueous solution of a water-soluble halide salt are continuously added with varying the concentration, as described in German Patent Application Publication No. 2,921,164; an apparatus in which reaction mother liquor is taken out of the reactor and subjected to ultrafiltration to perform concentration to maintain the distance between silver halide grains at a constant value, as described in JP-B No. 56-501776.

There may optionally used silver halide solvents such as a thioether. Compounds such as a mercapto group-containing compound, a nitrogen-containing heterocyclic compound or a sensitizing dye may be added during or after grain formation.

There can be employed commonly known chemical sensitization methods such as a sensitization method using gold compounds and a sensitization method using chalcogen compounds in solver halide emulsions used for the photographic material of the invention. Chalcogen sensitizers applicable to silver halide emulsions include sulfur sensitizers, selenium sensitizers and tellurium sensitizers. Of these, sulfur sensitizers are preferred. Examples of a sulfur sensitizer include a thiosulfate, allylthiocarbamate, thiourea, allylthioisocyanate, cystine, p-toluenethiosulfate, rhodanine, and inorganic sulfur. The addition amount of a sulfur sensitizer, which is variable depending on the kind of a silver halide emulsion to be applied and expected effects, is in the range of 5×10⁻¹⁰ to 5×10⁻⁵ mol per mol of silver halide, and preferably from 5×10⁻⁸ to 3×10⁻⁵ mol.

Gold complexes as well as chloroauric acid and gold sulfide are added as a gold sensitizer. Ligand compounds used therein include dimethylrhodanine, thiocyanic acid, mercaptotetrazole, and mercaptotriazole. The amount of a gold sensitizer to be used, depending on the kind of a silver halide emulsion, the kind of a compound to be used and ripening conditions, is preferably from 1×10⁻⁴ to 1×10⁻⁸ mol per mol of silver halide, and more preferably 1×10⁻⁵ to 1×10⁻⁸ mol.

The silver halide emulsion of the invention can achieve spectral sensitization in the desired wavelength region by addition of a dye (spectral sensitization dye) capable of absorbing light in the wavelength region corresponding to the intended spectral sensitization. Spectrally sensitizing dyes usable therein include, for example, compounds described in F. M. Hamer, Heterocyclic compounds Cyanine dyes and related compounds (John Wiley and Sons; New York, 1964). Examples of spectrally sensitizing dyes usable in the invention include cyanine dyes, merocyanine dyes, complex merocyanine dyes, complex cyanine dyes, holopolar cyanine dyes, hemi-cyanine dyes, styryl dyes and hemioxonol dyes. Cyanine dyes are preferably simple cyanine dyes, carbocyanine dyes and dicarbocyanine dyes.

A paper support which is coated with a resin layer on both sides of base paper is preferably used as a support. As such a paper support, a paper support laminated with polyolefin on both sides of the paper base is preferred, and polyethylene-laminated paper support is specifically preferred.

In addition to the foregoing constituent elements, the silver halide photographic material can employ commonly known antifoggants, stabilizers, anti-irradiation dyes, emulsion-dispersing methods, antistaining agents, hardeners, plasticizers, mordants, development accelerators, development retarders, fluorescent brighteners, matting agents, solvents, antistatic agents, surfactants, binders, supports, coating method, exposure method, and processing methods described, for example, in JP-A No. 11-34761, from page 9, left, line 22, paragraph [0044] to page 14, left, line 17, paragraph (0106).

Hereinafter, processing related to the invention will be described.

The replenishing rate of a color developing solution is characterized to be 30 to 100 ml per m² of photographic material, and preferably 30 to 75 ml.

The pH of a color developer replenishing solution is set to be preferably in the range of 10.0 to 13.0, and more preferably 10.5 to 13.0 in terms of achieving reduction of the replenishing rate. For example, the pH is preferably not less than 10.6 at a replenishing rate of not less than 30 ml/m² and not more than 75 ml/m², and more preferably not less than 10.9 at a replenishing rate of not less than 30 ml/m² and not more than 50 ml/m². Color developing agents usable in the invention are aromatic primary amine color developing agents. Specifically, p-phenylendiamine derivatives are preferred and specific examples thereof are shown below but are not limited to these.
1: N,N-diethyl-p-phenylenediamine,
2: 2-amino-5-diethylaminotoluene,
3: 2-amino-5-(N-ethyl-N-laulylamino)toluene
4: 4-amino-[N-ethyl-N-(β-hydroxyethyl)]amino-aniline,
5: 2-methyl-4-[N-ethyl-N-(β-hydroxyethyl)amino]aniline
6: 4-amino-3-methyl-N-ethyl-N-(β-methanesulfoneamido-ethyl)aniline,
7: N-(2-amino-5-diethylaminophenylethyl)methanesulfoneamide,
8: N,N-dimethyl-p-phenylenediamine,
9: 4-amino-3-methyl-N-ethyl-N-methoxyethylaniline,
10: 4-amino-3-methyl-N-ethyl-N-(β-methoxyethyl)aniline,
11: 4-amino-3-methyl-N-ethyl-N-(β-ethoxyethyl)aniline.

Of the foregoing p-phenylenediamine derivatives, 4-amino-3-methyl-N-ethyl-N-(β-methanesulfoneamidoethyl)-aniline (exemplified compound 6) and 2-methyl-4-[N-ethyl-N-(β-hydroxyethyl)amino]aniline (exemplified compound 5) are specifically preferred.

These p-phenylenediamine derivatives maybe in the form of a sulfate, hydrochloride, sulfite, or p-toluenesulfonic acid salt.

In the invention, the content of the above-described color developing agent is from 5.0 g to 20 g per liter of color developer replenishing solution. It is preferred to design a color developing agent at a relatively high content to achieve reduction of the replenishing rate. For example, the content is preferably not less than 10.0 g/L at a replenishing rate of 75 ml/m² and not less than 12.5 g/L at a replenishing rate of 30 ml/m².

Further, commonly known constituents are added to the developer replenishing solution. Buffering agents to maintain the pH value include, for example, sodium carbonate, potassium carbonate, sodium hydrogen carbonate, potassium hydrogen carbonate, trisodium phosphate, tripotassium phosphate, sodium metaphosphate, potassium metaphosphate, sodium salicylate, sodium 5-sulfosalicylate, and potassium 5-sulfosalicylate.

There are added various kinds of chelating agents, which are usable for preventing precipitation of calcium or magnesium or as a sequestering agent for Fe ion or Cu ion.

Examples of chelating agents include nitrilotriacetic acid, diethylenetriaminepentaacetic acid, ethylenediaminetetraacetic acid, N,N,N-trimethylenephosphonic acid, ethylenediamine-N,N,N′,N′-tetramethylenesulfonic acid, trans-siloxanediaminetetraacetic acid, 1,2-diaminopropanetetraacetic acid, glycol-ether-diaminetetraacetic acid, ethylenediamine-o-hydroxyphenylacetic acid, ethylenediamine-disuccinic acid (SS isomer), N-(2-carboxylateethyl)-L-asparagic acid, β-alaninediacetic acid, 2-phosphonobutane-1,2,4-tricarboxylic acid, 1-hydroxyethylidene-1,1-diphosphonic acid, 1-hydroxyethylidene-1,1-diphosphonic acid, N,N′-bis(2-hydroxybenzyl)ethylenediamine-N,N′-diacetic acid, and 1,2-dihydroxybenzene-4,6-disulfonic acid. These chelating agents may optionally be used in their combination. A chelating agent is used in an amount sufficient for sequestering metal ions contained in color developer solution, for example, 0.05 to 10.0 g per liter of color developer replenishing solution.

The developer solution used in the invention may contain a development accelerator. Examples of a development accelerator usable in the invention include thioether compounds described in JP-B Nos. 37-16088, 37-5987, 38-7826, 44-12380 and 45-9019, and U.S. Pat. No. 3,813,247; p-aminophenols (as described in U.S. Pat. Nos. 2,610,122 and 4,119,462); polyalkyleneoxide compounds described in JP-B Nos. 37-16088 and 42-25201, U.S. Pat. No. 3,128,183, JP-B Nos. 41-11431 and 42-23883, and U.S. Pat. No. 3,532,501. Chloride and bromide ions, and any fog inhibitor may be added. Examples of a fog inhibitor include organic fog inhibitors such as benzotriazole, 6-nitrobenzimidazole, 5-nitroisoindazole, 5-nitrobenzotriazole and adenine.

To enhance whiteness of the background, the color developer replenishing solution of the invention can advantageously use fluorescent brighteners such as 4,4′-diamino-2,2′-disulfostilben type compounds. The amount thereof is preferably from 0.2 to 10 g per liter of color developer replenishing solution, and moe preferably from 0.5 to 5.0 g.

A fixer solution, a bleaching solution, a bleach-fixing solution and a stabilizer solution can use commonly known composition and composite solution.

Hereinafter, the present invention will be described based on examples but embodiments of the invention are by no means limited to these.

### EXAMPLE 1

### Silver Halide Photographic Material

### Preparation of Sample 1

Preparation of Silver Halide Emulsion

Silver halide emulsions were prepared in the manner described below.

Preparation of Red-Sensitive Silver Halide Emulsion

To 1 liter of aqueous 2% gelatin solution kept at 40° C. were simultaneously added the following solutions (A) and (B) over a period of 30 min., while being maintained at a pAg of 7.3 and pH of 3.0, and further thereto were added solutions (C) and (D) for a period of 180 min., while being maintained at a pAg of 8.0 and pH of 5.5. The pAg was controlled according to the method described in JP-A No. 59-45437 and the pH was controlled using aqueous sulfuric acid or sodium hydroxide solution.

Solution A

| | | |
|---|---|---|
| Sodium chloride | 3.42 | g |
| Potassium bromide | 0.03 | g |
| Water to make | 200 | ml |

Solution B

| | | |
|---|---|---|
| Silver nitrate | 10 | g |
| Water to make | 200 | ml |

Solution C

| | | |
|---|---|---|
| Sodium chloride | 102.7 | g |
| K₂IrCl₆ | 4 × 10⁻⁸ | mol/mol Ag |
| K₄Fe(CN)₆ | 2 × 10⁻⁵ | mol/mol Ag |
| Potassium bromide | 1.0 | g |
| Water to make | 600 | ml |

Solution D

| | | |
|---|---|---|
| Silver nitrate | 300 | g |
| Water to make | 600 | ml |

After completing the addition, the resulting emulsion was desalted using a 5% aqueous solution of Demol N (produced by Kao-Atlas) and aqueous 20% magnesium sulfate solution, and re-dispersed in a gelatin aqueous solution to obtain a monodisperse cubic grain emulsion (EMP-1) having an average grain size of 0.40 μm, a coefficient of variation of grain size of 0.07 and a chloride content of 99.5 mol %. Monodisperse cubic grain emulsions, EMP-1B having an average grain size of 0.38 μm, a coefficient of variation of grain size of 0.07 and a chloride content of 99.5 mol % was prepared similarly to EMP-1, provided that the addition time of Solutions A and B and the addition time of Solutions C and D were respectively varied.

The thus obtained emulsion, EMP-1 was chemically sensitized at 60° C. using the following compounds. Similarly, emulsion EMP-1B was chemically sensitized. These emulsions EMP-1 and EMP-1B were blended in a ratio of 1:1 to obtain a red-sensitive silver halide emulsion (101).

| | | |
|---|---|---|
| Sodium thiosulfate | 1 × 10⁻⁴ | mol/mol AgX |
| Chloroauric acid | 1.2 × 10⁻⁴ | mol/mol AgX |
| Stabilizer STAB-1 | 3 × 10⁻⁴ | mol/mol AgX |
| Stabilizer STAB-2 | 3 × 10⁻⁴ | mol/mol AgX |
| Stabilizer STAB-3 | 3 × 10⁻⁴ | mol/mol AgX |
| Sensitizing dye RS-1 | 1 × 10⁻⁴ | mol/mol AgX |
| Sensitizing dye RS-2 | 1 × 10⁻⁴ | mol/mol AgX |

STAB-1: 1-(3-acetoamidophenyl)-5-mercaptotetrazole
STAB-2: 1-phenyl-5-mercaptotetrazole
STAB-3: 1-(4-ethoxyphenyl)-5-mercaptotetrazole

To the red-sensitive emulsion was added SS-1 of 2.0×10⁻³ mol/mol AgX.

Preparation of Green-Sensitive Silver Halide Emulsion

Monodisperse cubic grain emulsion, EMP-2 having an average grain size of 0.40 μm, a coefficient of variation of grain size of 0.08 and a chloride content of 99.5 mol % was prepared similarly to EMP-1, provided that the addition time of Solutions A and B and the addition time of Solutions C and D were respectively varied. Monodisperse cubic grain emulsion, EMP-0.2B having an average grain size of 0.50 μm, a coefficient of variation of grain size of 0.08 and a chloride content of 99.5 mol % was prepared similarly to EMP-1, provided that the addition time of Solutions A and B and the addition time of Solutions C and D were respectively varied.

The thus obtained emulsion, EMP-2 was chemically sensitized at 55° C. using the following compounds. Similarly, emulsion EMP-2B was chemically sensitized. These emulsions EMP-2 and EMP-2B were blended in a ratio of 1:1 to obtain a blue-sensitive silver halide emulsion (101G).

| | | |
|---|---|---|
| Sodium thiosulfate | 1 × 10⁻⁴ | mol/mol AgX |
| Chloroauric acid | 1.2 × 10⁻⁴ | mol/mol AgX |
| Stabilizer STAB-1 | 2.5 × 10⁻⁴ | mol/mol AgX |
| Stabilizer STAB-2 | 3.1 × 10⁻⁴ | mol/mol AgX |
| Stabilizer STAB-3 | 3.1 × 10⁻⁴ | mol/mol AgX |
| Sensitizing dye GS-1 | 4 × 10⁻⁴ | mol/mol AgX |

Preparation of Blue-Sensitive Silver Halide Emulsion

Monodisperse cubic grain emulsions, EMP-3 having an average grain size of 0.71 μm, a coefficient of variation of grain size of 0.08 and a chloride content of 99.5 mol % was prepared similarly to EMP-1, provided that the addition time of Solutions A and B and the addition time of Solutions C and D were respectively varied. Monodisperse cubic grain emulsions, EMP-3B having an average grain size of 0.64 μm, a coefficient of variation of grain size of 0.08 and a chloride content of 99.5 mol % was prepared similarly.

The thus obtained emulsion, EMP-3 was chemically sensitized at 60° C. using the following compounds. Similarly, emulsion EMP-3B was chemically sensitized. These emulsions EMP-3 and EMP-3B were blended in a ratio of 1:1 to obtain a red-sensitive silver halide emulsion (Em-R).

| | | |
|---|---|---|
| Sodium thiosulfate | 1 × 10⁻⁴ | mol/mol AgX |
| Chloroauric acid | 1.2 × 10⁻⁴ | mol/mol AgX |
| Stabilizer STAB-1 | 2 × 10⁻⁴ | mol/mol AgX |
| Stabilizer STAB-2 | 2.4 × 10⁻⁴ | mol/mol AgX |
| Stabilizer STAB-3 | 2.1 × 10⁻⁴ | mol/mol AgX |
| Sensitizing dye BS-1 | 4 × 10⁻⁴ | mol/mol AgX |
| Sensitizing dye BS-2 | 1 × 10⁻⁴ | mol/mol AgX |

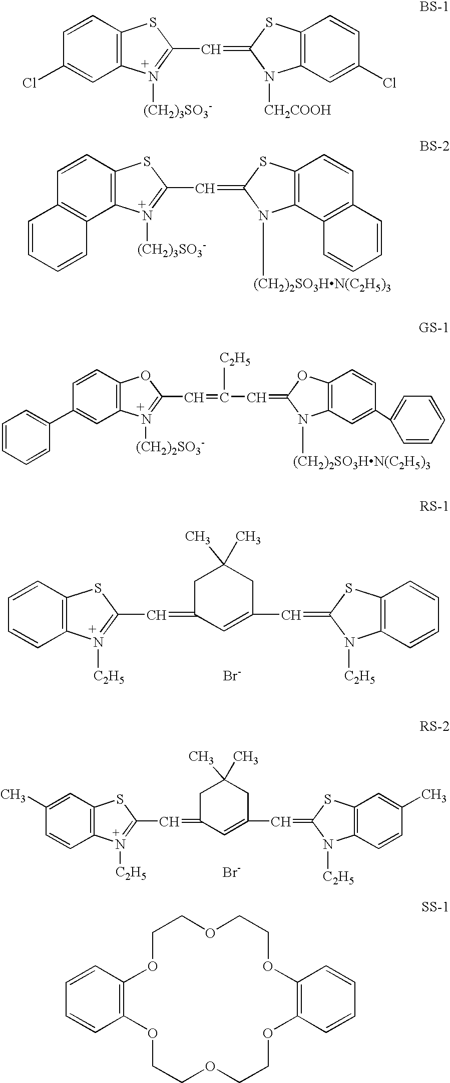 Preparation of Color Photographic Material

There was prepared a reflective support A laminated, on both sides of paper of a weight of 180 g/m², with polyethylene, provided that the side to be coated with an emulsion layer was laminated with polyethylene melt containing surface-treated anatase type titanium oxide in an amount of 15% by weight.

The reflective support was subjected to corona discharge and a sublayer was provided, and further thereon, the following component layers were provided to prepare a silver halide color photographic material sample 101. Coating solutions are as follows.

1st Layer Coating Solution:

To 23.4 g of yellow coupler (Y-1), 3.34 g of dye image stabilizer (ST-1), 3.34 g of dye image stabilizer (ST-2), 3.34 g of dye image stabilizer (ST-5), 0.34 g of antistaining agent (HQ-1), 5.0 g of image stabilizer A, 3.33 g of high boiling organic solvent (DBP) and 1.67 g of high boiling solvent (DNP) was added 60 ml of ethyl acetate. Using an ultrasonic homogenizer, the resulting solution was dispersed in 220 ml of an aqueous 10% gelatin solution containing 7 ml of an aqueous 20% surfactant (SU-1) solution to obtain a yellow coupler dispersion. The obtained dispersion was mixed with a blue-sensitive silver halide emulsion (101B) prepared as below to prepare a 1st layer coating solution.

2nd to 7th Layer Coating Solution:

Coating solutions for the 2nd layer to 7th layer were each prepared similarly to the 1st layer coating solution, and the respective coating solutions were coated so as to have a coating amount as shown below.

Constitution of Sample 101:

g/m²

7th Layer (Protective layer)

| | |
|---|---|
| Gelatin | 1.00 |
| DIDP | 0.005 |
| Silicon dioxide | 0.003 |

6th Layer (UV absorbing layer)

| | |
|---|---|
| Gelatin | 0.40 |
| UV absorbent (UV-1) | 0.12 |
| UV absorbent (UV-2) | 0.04 |
| UV absorbent (UV-3) | 0.16 |
| Antistaining agent (HQ-5) | 0.04 |
| PVP (Polyvinylpyrrolidone) | 0.03 |
| Antiirradiation dye (AI-1) | 0.01 |

5th Layer (Red-sensitive layer)

| | |
|---|---|
| Gelatin | 1.30 |
| Red-sensitive emulsion (101R) | 0.21 |
| Cyan coupler (C-1) | 0.25 |
| Cyan coupler (C-2) | 0.08 |
| Dye image stabilizer (ST-1) | 0.10 |
| Antistaining agent (HQ-1) | 0.004 |
| DOP | 0.34 |

4th Layer (UV absorbing layer)

| | |
|---|---|
| Gelatin | 0.94 |
| UV absorbent (UV-1) | 0.28 |
| UV absorbent (UV-2) | 0.09 |
| UV absorbent (UV-3) | 0.38 |
| Antistaining agent (HQ-5) | 0.10 |
| Antiirradiation dye (AI-1) | 0.02 |

3rd Layer (Green-sensitive layer)

| | |
|---|---|
| Gelatin | 1.30 |
| Green-sensitive Emulsion (101G) | 0.14 |
| Magenta coupler (exemplified | 0.20 |
| magenta coupler 7) | |
| DIDP | 0.13 |
| DBP | 0.13 |
| Antiirradiation dye (AI-2) | 0.01 |

2nd Layer (Interlayer)

| | |
|---|---|
| Gelatin | 1.20 |
| Antistaining agent (HQ-2) | 0.03 |
| Antistaining agent (HQ-3) | 0.03 |
| Antistaining agent (HQ-4) | 0.05 |
| Antistaining agent (HQ-5) | 0.23 |
| DIDP | 0.06 |
| Brightener (W-1) | 0.10 |
| Antiirradiation dye (AI-3) | 0.01 |

1st Layer (Blue-sensitive layer)

| | |
|---|---|
| Gelatin | 1.20 |
| Blue-sensitive Emulsion (101B) | 0.26 |
| Yellow coupler (Y-1) | 0.70 |
| Dye image stabilizer (ST-1) | 0.10 |
| Dye image stabilizer (ST-2) | 0.10 |
| Antistaining agent (HQ-1) | 0.01 |
| Image stabilizer (ST-5) | 0.10 |
| Image stabilizer A | 0.15 |
| DNP | 0.05 |
| DBP | 0.10 |

Support

Polyethylene-laminated paper
(containing a slight amount of
colorant)

The amount of silver halide was represented by an equivalent converted to silver. Additives used in sample 101 are as follows. To the respective coating solutions, hardeners (H-1) and (H-2) were added and surfactant (SU-1) and (SU-2) were added as a coating aid to adjust a surface tension. Antiseptic (F-1) was appropriately added.
SU-1: Sodium tri-1-propylnaphthalenesulfonate
SU-2: Sodium di-(2-ethylhexyl)sufosuccinate
SU-3: Sodium di-(2,2,3,3,4,4,5,5-octafluoropentyl)-succinate
DBP: Dibutyl phthalate
DNP: Dinonyl phthalate
DOP: Dioctyl phthalate
DIDP: Diisodecyl phthalate
H-1: tetrakis(vinylsulfonylmethyl)methane
H-2: 2,4-Dichloro-6-hydroxy-s-triazine sodium salt
HQ-1: 2,5-Di-t-octylhydroquinone
HQ-2: 2,5-Di-sec-dodecylhydroquinone
HQ-3: 2,5-Di-sec-tetradecylhydroquinone
HQ-4: 2-sec-Dodecyl-5-sec-tetradecylhydoquinone
HQ-5: 2,5-Di(1,1-dimethyl-4-hexyloxycarbonyl)-butylhydroqinone
Image stabilizer A: p-t-Octylphenol 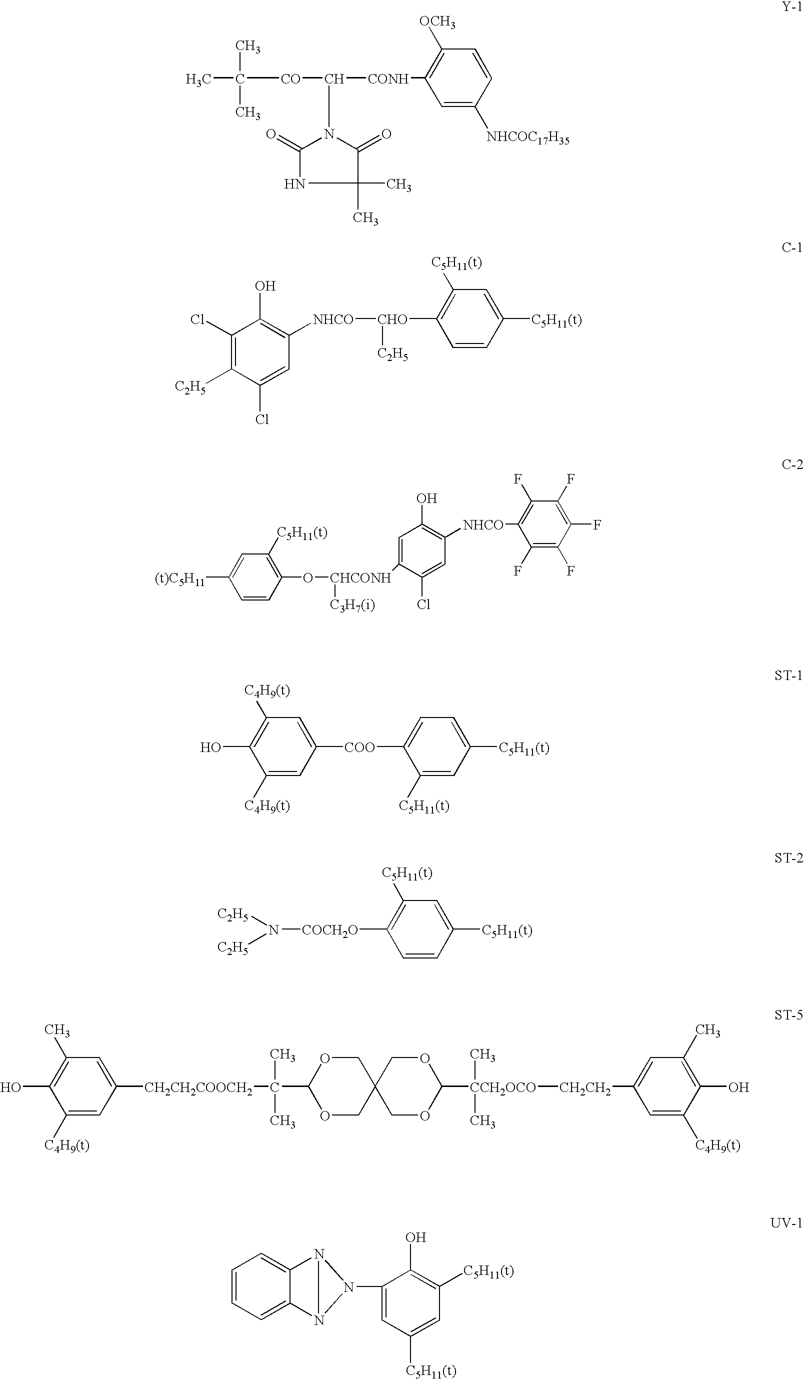 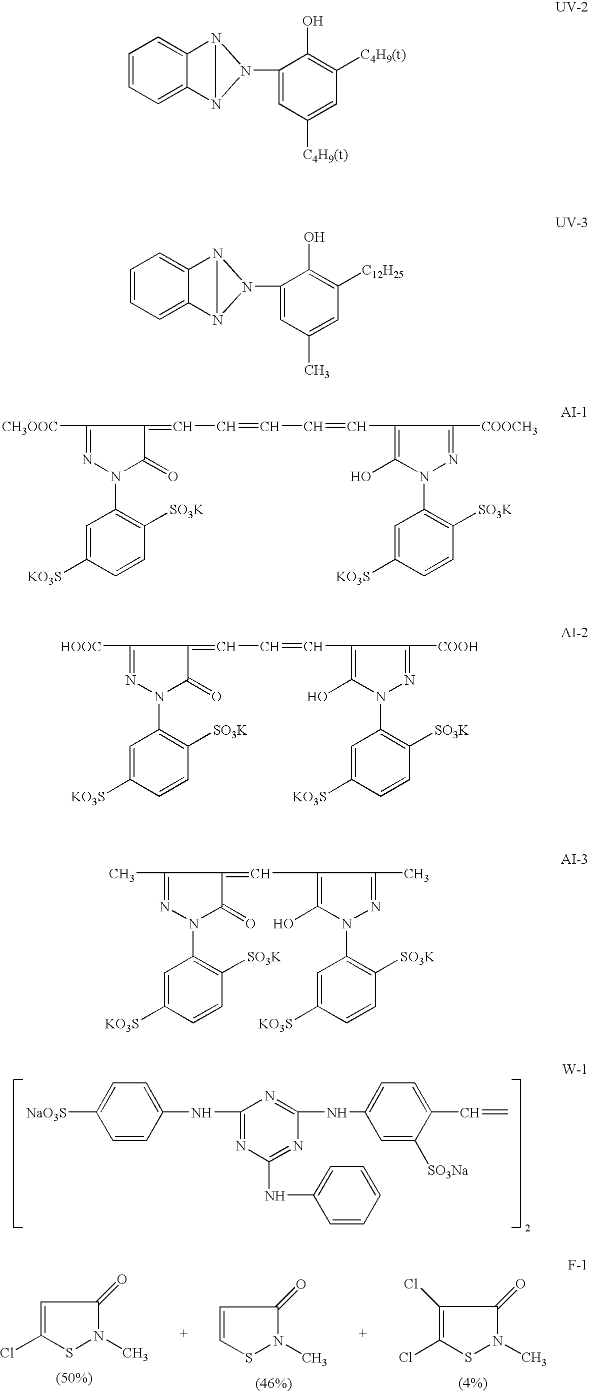
   molar ratio
   Preparation of Sample 102 to 104

Samples 102 to 104 were prepared similarly to the foregoing sample 101, except that the magenta coupler (exemplified coupler 7) used in the 3rd layer (green-sensitive layer) was replaced as shown in the following Table.

Preparation of Sample 105 to 121

Samples 105 to 121 were prepared similarly to the foregoing sample 101, except that the magenta coupler (exemplified coupler 7) used in the 3rd layer (green-sensitive layer) was replaced as shown in the following Table and a dye image stabilizer (I-1 or II-2) was added to the 3rd layer in an amount of 0.37 g/m².

Preparation of Sample 122 to 138

Samples 122 to 138 were prepared similarly to the foregoing sample 101, except that the magenta coupler (exemplified coupler 7) used in the 3rd layer (green-sensitive layer) was replaced by the combination of couplers of formula. (M-1) or (M-2), as shown in the following Table, and a dye image stabilizer (I-1 or II-2) was added to the 3rd layer in an amount of 0.37 g/m² or dye image stabilizers (I-1/II-2) was added in an amount of 0.20/0.17 g/m².

| Sample | Magenta Coupler | | | | Dye Image | |
|---|---|---|---|---|---|---|
| No. | (3rd layer) | | | | Stabilizer | Remark |
| 101 | 7 | (100%) | — | | — | Comp. |
| 102 | 8 | (100%) | — | | — | Comp. |
| 103 | 21 | (100%) | — | | — | Comp. |
| 104 | 22 | (100%) | — | | — | Comp. |
| 105 | 1 | (100%) | — | | I-1 | Comp. |
| 106 | 2 | (100%) | — | | I-1 | Comp. |
| 107 | 5 | (100%) | — | | I-1 | Comp. |
| 108 | 6 | (100%) | — | | I-1 | Comp. |
| 109 | 7 | (100%) | — | | I-1 | Comp. |
| 110 | 8 | (100%) | — | | I-1 | Comp. |
| 111 | 21 | (100%) | — | | I-1 | Comp. |
| 112 | 22 | (100%) | — | | I-1 | Comp. |
| 113 | 1 | (100%) | — | | II-2 | Comp. |
| 114 | 2 | (100%) | — | | II-2 | Comp. |
| 115 | 5 | (100%) | — | | II-2 | Comp. |
| 116 | 6 | (100%) | — | | II-2 | Comp. |
| 117 | 7 | (100%) | — | | II-2 | Comp. |
| 118 | 8 | (100%) | — | | II-2 | Comp. |
| 119 | 9 | (100%) | — | | II-2 | Comp. |
| 120 | — | | 21 | (100%) | II-2 | Comp. |
| 121 | — | | 22 | (100%) | II-2 | Comp. |
| 122 | 7 | (99.9%) | 8 | (0.1%) | I-1 | Inv. |
| 123 | 7 | (99.5%) | 8 | (0.5%) | I-1 | Inv. |
| 124 | 7 | (99.0%) | 8 | (1.0%) | I-1 | Inv. |
| 125 | 7 | (98.0%) | 8 | (2.0%) | I-1 | Inv. |
| 126 | 7 | (99.9%) | 8 | (0.1%) | II-2 | Inv. |
| 127 | 7 | (99.5%) | 8 | (0.5%) | II-2 | Inv. |
| 128 | 7 | (99.0%) | 8 | (1.0%) | II-2 | Inv. |
| 129 | 7 | (98.0%) | 8 | (2.0%) | II-2 | Inv. |
| 130 | 21 | (99.5%) | 22 | (0.5%) | I-1 | Inv. |
| 131 | 21 | (99.0%) | 22 | (1.0%) | I-1 | Inv. |
| 132 | 21 | (99.5%) | 22 | (0.5%) | II-2 | Inv. |
| 133 | 21 | (99.0%) | 22 | (1.0%) | II-2 | Inv. |
| 134 | 9 | (99.5%) | 10 | (0.5%) | I-1 | Inv. |
| 135 | 9 | (99.5%) | 10 | (0.5%) | II-2 | Inv. |
| 136 | 1 | (99.5%) | 2 | (0.5%) | I-1 | Inv. |
| 137 | 5 | (99.9%) | 6 | (0.5%) | II-2 | Inv. |
| 138 | 7 | (99.5%) | 8 | (0.5%) | I-2/II-2 | Inv. |

The thus prepared samples were each subjected to print exposure through a color negative film in which a photograph of a black dress suit was taken and processed to examine process variation of magenta color portions using running solutions at 1 week after the start of the normal process.

| Processsing Step | Temperature | | Time | Repl. Rate |
|---|---|---|---|---|
| Color developing | 38.0 ± 0.3° | C. | 45 sec. | shown below |
| Bleach-fixing | 35.0 ± 0.5° | C. | 45 sec. | 120 ml |
| Stabilizing | 30-34° | C. | 60 sec. | 150 ml |
| Drying | 60-80° | C. | 30 sec. | |

The replenishing rate (Repl. Rate) of the color developer was 20 ml, 30 ml. 75 ml, 100 ml or 150 ml per m² of photographic material.

Composition of processing solution is shown below.

Color developer (Tank solution, Replenisher)

| | Tank soln. | | Replenisher | |
|---|---|---|---|---|
| Water | 800 | ml | 800 | ml |
| Triethylenediamine | 2 | g | 3 | g |
| Diethylene glycol | 10 | g | 10 | g |
| Potassium bromide | 0.01 | g | — | |
| Potassium chloride | 3.5 | g | — | |
| Potassium sulfite | 0.25 | g | 0.5 | g |
| N-ethyl-N(β-methanesulfonamidoethyl)- | 6.0 | g | 10.0 | g |
| 3-methyl-4-aminoaniline sulfate | | | | |
| N,N-diethylhydroxyamine | 6.8 | g | 6.0 | g |
| Triethanolamine | 10.0 | g | 10.0 | g |
| Sodium diethyltriaminepentaacetate | 2.0 | g | 2.0 | g |
| Brightener (4,4′-diaminostilbene- | 2.0 | g | 2.5 | g |
| disulfonate derivative) | | | | |
| Potassium carbonate | 30 | g | 30 | g |

Water is added to make 1 liter, and the pH of the tank solution and replenisher were respectively adjusted to 10.10 and 10.60 with sulfuric acid or potassium hydroxide.

Bleach-fixer (Tank solution, Replenisher)

| | | |
|---|---|---|
| Diethylenetriaminepentaacetic acid | 65 | g |
| iron (III) ammonium salt dihydrate | | |
| Diethylenetriaminepentaacetic acid | 3 | g |
| Ammonium thiosulfate (70% aqueous solution) | 100 | ml |
| 2-Amino-5-mercapto-1,3,4-thiadiazole | 2.0 | g |
| Ammonium sulfite (40% aqueous solution) | 27.5 | ml |

Water is added to make 1 liter, and the pH is adjusted to 5.0.

Stabilizer (Tank solution, Replenisher)

| | | |
|---|---|---|
| o-Phenylphenol | 1.0 | g |
| 5-Chloro-2-methyl-4-isothiazoline-3-one | 0.02 | g |
| 2-Methyl-4-isothiazoline-3-one | 0.02 | g |
| Diethylene glycol | 1.0 | g |
| Brightener (Chinopal SFP) | 2.0 | g |
| 1-Hydroxyethylidene-1,1-diphosphonic acid | 1.8 | g |
| Bismuth chloride (45% aqueous solution) | 0.65 | g |
| Magnesium sulfate hepta-hydrate | 0.2 | g |
| Polyvinyl pyrrolidone | 1.0 | g |
| Ammonia water (25% aqueous | 2.5 | g |
| ammonium hydroxide solution) | | |
| Trisodium nitrilotriacetate | 1.5 | g |

Water is added to make 1 liter, and the pH is adjusted to 7.5 with sulfuric acid or ammonia water.

The thus obtained prints were visually evaluated by 10 persons with respect to the black portion of the dress suit, based on the following criteria of 10 ranks. Thus, the extent of variation of contrast balance was evaluated by the average value:
1: the black portion is green-colored or magenta-colored and markedly unnatural tone,
5: the black portion is slightly green-colored or slightly magenta-colored and slightly unnatural tone,
10: the black portion is recognized as black and natural tone.

Ranks other than the foregoing were set by equally diving the foregoing ranks into the respective ranks.

The thus obtained evaluation results are shown below.

| | Color Developer | | | | | |
|---|---|---|---|---|---|---|
| | Replenishing Rate | | | | | |
| Sample | (ml/m²) | | | | | |
| No. | 20 | 30 | 75 | 100 | 150 | Remark |
| 101 | 1 | 1 | 2 | 3 | 8 | Comp. |
| 102 | 2 | 2 | 3 | 4 | 7 | Comp. |
| 103 | 2 | 2 | 3 | 4 | 8 | Comp. |
| 104 | 2 | 2 | 3 | 4 | 8 | Comp. |
| 105 | 2 | 2 | 3 | 4 | 8 | Comp. |
| 106 | 2 | 2 | 3 | 4 | 8 | Comp. |
| 107 | 2 | 2 | 3 | 4 | 7 | Comp. |
| 108 | 2 | 2 | 3 | 4 | 8 | Comp. |
| 109 | 2 | 2 | 3 | 4 | 7 | Comp. |
| 110 | 2 | 2 | 3 | 4 | 8 | Comp. |
| 111 | 2 | 2 | 3 | 4 | 8 | Comp. |
| 112 | 2 | 2 | 3 | 4 | 8 | Comp. |
| 113 | 1 | 2 | 3 | 4 | 8 | Comp. |
| 114 | 2 | 2 | 3 | 3 | 8 | Comp. |
| 115 | 2 | 1 | 3 | 4 | 7 | Comp. |
| 116 | 2 | 2 | 3 | 4 | 8 | Comp. |
| 117 | 2 | 2 | 2 | 4 | 7 | Comp. |
| 118 | 1 | 2 | 3 | 4 | 8 | Comp. |
| 119 | 2 | 2 | 3 | 4 | 8 | Comp. |
| 120 | 1 | 2 | 3 | 4 | 8 | Comp. |
| 121 | 2 | 2 | 3 | 4 | 8 | Comp. |
| 122 | 2 | 4 | 5 | 6 | 6 | Inv. |
| 123 | 2 | 6 | 7 | 8 | 9 | Inv. |
| 124 | 2 | 5 | 6 | 7 | 8 | Inv. |
| 125 | 2 | 4 | 5 | 6 | 7 | Inv. |
| 126 | 2 | 4 | 5 | 7 | 8 | Inv. |
| 127 | 2 | 7 | 8 | 8 | 10 | Inv. |
| 128 | 2 | 5 | 6 | 7 | 9 | Inv. |
| 129 | 2 | 4 | 5 | 6 | 6 | Inv. |
| 130 | 2 | 5 | 7 | 8 | 9 | Inv. |
| 131 | 2 | 5 | 7 | 7 | 8 | Inv. |
| 132 | 2 | 5 | 7 | 8 | 9 | Inv. |
| 133 | 3 | 5 | 7 | 8 | 8 | Inv. |
| 134 | 2 | 5 | 7 | 8 | 8 | Inv. |
| 135 | 3 | 5 | 6 | 7 | 7 | Inv. |
| 136 | 2 | 5 | 6 | 7 | 7 | Inv. |
| 137 | 2 | 5 | 7 | 8 | 8 | Inv. |
| 138 | 3 | 7 | 8 | 8 | 10 | Inv. |

As apparent from the foregoing results, it was proved that samples composed of the constitution defined in the invention resulted in an improvement in contrast balance variation, compared to comparative samples, even when replenished at a relatively low rate of 100 ml/m² or less of a color developer replenishing solution, and exhibited superior black color reproduction. Specifically, it was noted that improved development stability was achieved when replenished at a low rate of 30 ml to 75 ml.

### EXAMPLE 2

Similarly to Example 1, processing was run using automatic processor NPS-868J (produced by Konica Corp.) and ECOJET-P as processing chemicals according to process CPK-J1. Evaluation was made similarly to Example 1 and it was confirmed that samples of the invention exhibited improved contrast variation and superior black color reproduction, compared to comparative samples.

### INDUSTRIAL APPLICABILITY

According to the constitution of the present invention, there can be provided a silver halide photographic material exhibiting superior process stability even when processed at a relatively low replenishing rate.

1. A silver halide photographic material comprising on a support at least one silver halide emulsion layer, wherein the silver halide emulsion layer contains at least two image-forming couplers represented by the following formula (M-1) or (M-2); the photographic material is developed with a color developer solution while replenishing a color developer replenishing solution at a replenishing rate of 30 to 100 ml per 1 m², and the color developer replenishing solution containing a color developing agent in an amount of 5.0 to 20 g/L: 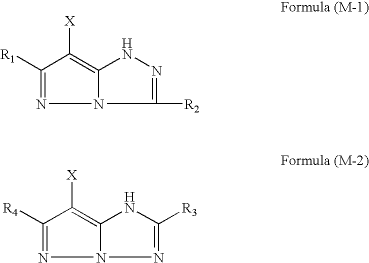
wherein R₁ and R₄ are each a hydrogen atom or a substituent; R₂ and R₃ are each a substituent, provided that the substituent represented by R₂ and R₃ contains an alkyl group having at least 6 carbon atoms and a difference in number of carbon atoms of the alkyl group contained in the substituent represented by R₂ or R₃ between the two couplers is at least 2; X is a group capable of being released upon reaction with an oxidation product of a color developing agent.

2. The silver halide photographic material as claimed in claim 1, wherein the silver halide emulsion layer containing the couplers represented by formula (M-1) or (M-2) further contains a compound represented by the following formula (I) or (II): 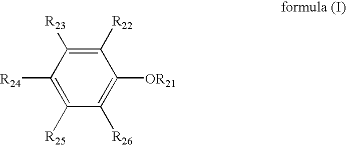
wherein R₂₁ is a hydrogen atom, an alkyl group, an aryl group, a heterocyclic group or a group represented by the following formula: 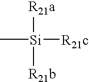
in which R₂₁a, R₂₁b and R₂₁c are each a univalent organic group; R₂₂, R₂₃, R₂₄, R₂₅ and R₂₆ are each a hydrogen atom, a halogen atom or a group capable of being substituted on a benzene ring, provided that R₂₁ to R₂₆ may combined with each other to form a ring; 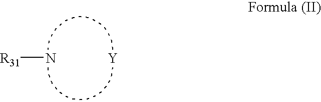
wherein R₃₁ is an aliphatic group or an aromatic group; Y is a non-metallic atom group necessary to form a 5- to 7-membered ring together with a nitrogen atom.

3. The silver halide photographic material as claimed in claim 1, wherein the couplers represented by formula (M-1) or (M-2) exhibit a pKa of not less than 9.5.

4. The silver halide photographic material as claimed in claim 2, wherein the couplers represented by formula (M-1) or (M-2) exhibit a pKa of not less than 9.5.
